(19) United States
(12) Patent Application Publication
(10) Pub. No.: US 2017/0086946 A1
(43) Pub. Date: Mar. 30, 2017

(54) ORTHODONTIC BRACKET WITH CONTROLLED ADHESIVE FLOW

(71) Applicant: DENTSPLY International Inc., York, PA (US)

(72) Inventors: Tieming RUAN, Setauket, NY (US); Sivaramakrishnan KRISHNAMOORTHY, Albertson, NY (US); Andrew Murray LICHKUS, York, PA (US)

(21) Appl. No.: 14/871,385

(22) Filed: Sep. 30, 2015

(51) Int. Cl. A61C 7/16

(52) U.S. Cl. CPC A61C 7/16

(57) ABSTRACT

An orthodontic bracket (10) of the type to be bonded to a patient's tooth has a base (22) and a side proximal (20) to a patient's tooth when positioned thereon. Proximal side (20) is provided with flow path regulating structures (30) that define a prescribed flow path for bonding material (32) when the bracket (10) is pressed to a tooth. Areas (40, 50) are provided as catchments for excess bonding material to thereby reduce the occurrence of flash.

### TECHNICAL FIELD

The present invention is generally directed toward an orthodontic bracket that is adhesively bonded to a patient's tooth. More particularly the invention relates to such a bracket having structure to control the flow path of adhesive or cement as the bracket is bonded or affixed to a tooth. The inventive bracket so configured helps to reduce the tendency for excess adhesive to flash when the bracket is placed upon a tooth.

### BACKGROUND OF THE INVENTION

It is known in the orthodontic art to bond brackets to a patient's tooth. The brackets are then wired in various ways to exert a planned force upon a given tooth or teeth. It is also known in the art to adhesively bond or cement such a bracket to a tooth. Often an amount of cement, adhesive or bonding material (the terms being used interchangeably herein) is applied to the bottom of the bracket that is placed proximate to and directly upon the tooth. The bracket is then pressed toward the tooth and the bonding material is caused to flow or “spread out” between the bracket and the tooth. It will be appreciated that it would be desirable to direct the flow of such bonding material in a controlled and consistent manner, an activity that has heretofore proven difficult to achieve with any certainty or regularity with known devices.

Further, excess such bonding material may flash away from the bracket and should be removed for various reasons including for example, aesthetics and oral hygiene. An example of an orthodontic bracket that is bonded to a tooth, together with a discussion of flashing is shown in U.S. Pat. No. 4,063,360 which is hereby incorporated by reference for such disclosure.

### SUMMARY OF THE INVENTION

In the following description, certain aspects and embodiments of the present invention will become evident. It should be understood that the invention, in its broadest sense, could be practiced without having one or more features of these aspects and embodiments. In other words, these aspects and embodiments are merely exemplary.

According to the invention, an orthodontic bracket of the type that it adhesively bonded or cemented with a bonding material to a tooth has a side distal to the tooth and a side proximate to the tooth when in place upon the tooth. An amount of the boding material will be placed upon the proximal side of the bracket; the proximal side of the bracket will then be placed in physical contact with the tooth; and, a clinically relevant force will be applied as will be understood by the practitioner. The proximal side of the bracket is provided with structure such that when the force is applied, the bonding material will be forced into a predetermined flow path in order to facilitate a proper placement of the material. This allows for more precise and consistent bonding of the bracket to a patient's tooth. Further, in this manner, the expression of excess material from between the bracket and the tooth, commonly referred to as “flash” is controlled, minimized or even eliminated.

In a further embodiment of the invention, the flow path defining structure includes a plurality of monolithic structures posts or columns. Such structures may be round, square, rectangular, triangular, irregularly shaped or combinations thereof. Each individual flow path defining structure of such a plurality may be the same or different size and shape as compared to the other such structures of the plurality.

According to another embodiment of the invention, the inventive bracket proximal side is further provided with at least one catchments or void areas where excess bonding material can be collected to still further reduce flash.

In an additional embodiment of the invention, at least one of the posts of columns are positioned in a well in the proximal side of the bracket, such that the well itself defines a catchment area to control the spread of excess bonding material, thereby reducing flash.

Aside from the structural and procedural arrangements set forth above, the invention could include a number of other arrangements such as those explained hereinafter. It is to be understood that both the foregoing description and the following description are exemplary only.

### BRIEF DESCRIPTION OF THE DRAWINGS

The accompanying drawings are incorporated in and constitute a part of this specification. The drawings illustrate exemplary embodiments and, together with the description, serve to explain some principles of the invention.

FIG. 1 is a bottom plan view of an orthodontic bracket embodying the concepts of the present invention.

FIG. 2 is a perspective view of the bracket of FIG. 1.

FIG. 3 is a is a bottom plan view of the bracket of FIG. 1 showing the placement of an amount of bonding material prior to placement of the bracket upon a tooth.

FIG. 4 is a bottom plan view of the bracket of FIG. 1 showing by arrows the general direction of a flow path of bonding material according to the invention.

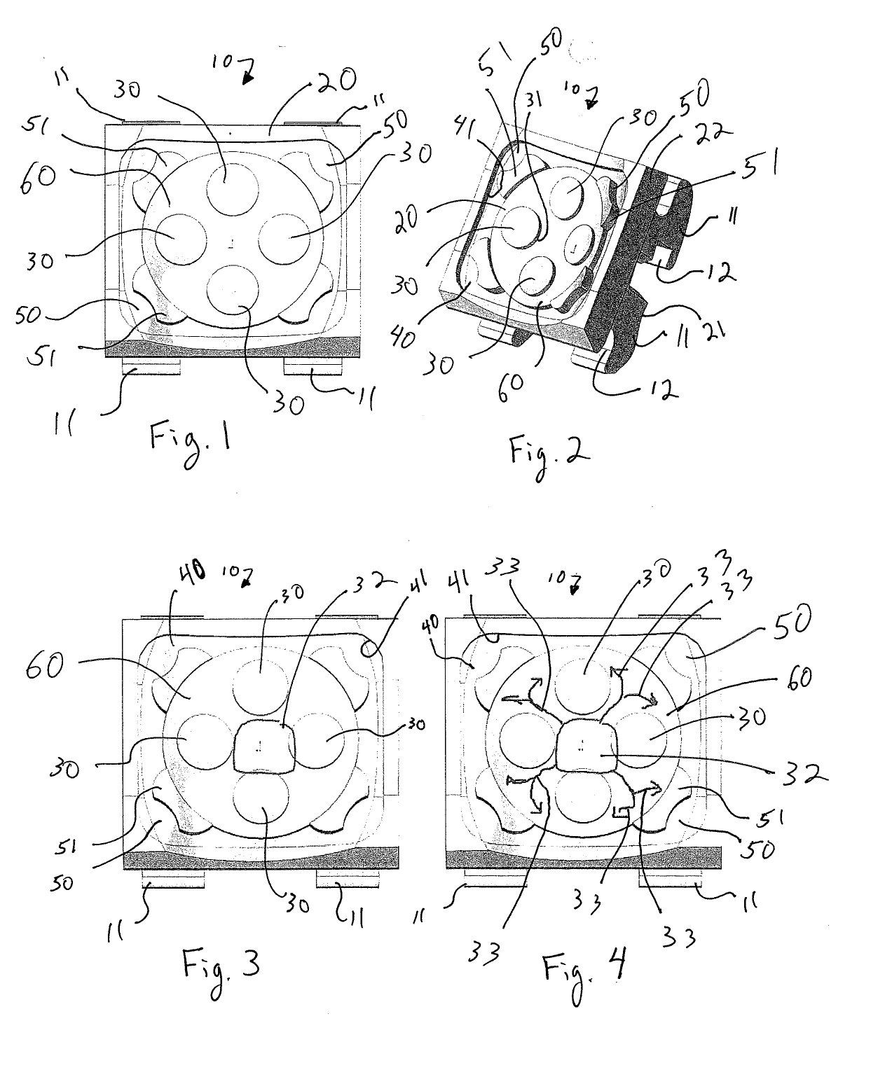

### DETAILED DESCRIPTION OF THE EXEMPLARY EMBODIMENTS

An orthodontic bracket embodying the concepts of the present invention is shown by way of example as bracket 10 on the attached drawings. Bracket 10 is of the general type known in the industry as that which is adhesively bonded or cemented using a bonding material, to a patient's tooth (not shown). Bracket 10 may be provided with conventional structure such as tie wings 11 and slots 12 to which a conventional orthodontic wire (not shown) may be attached in a known manner.

As is the case with orthodontic brackets known in the industry, bracket 10 has a side proximal 20 to the patient's tooth when bracket 10 is affixed to the tooth. When positioned on a tooth and in use, proximal side 20 may be thought of as facing the patient's tongue, a direction known as the lingual side of the patient's oral cavity (not shown). Bracket 10 also has a side 21 distal to the tooth when in place thereon, facing the patient's cheek or lips (not shown) and known as the labial side of the oral cavity. Bracket 10 has a base 22 that may carry or support tie wings 11 on one side and proximal side 20 on another.

According to one aspect of the invention, proximal side 20 is provided with flow path regulating structures 30 of a predetermined size and shape, as will be more fully discussed in the following. Flow path regulating structures 30 preferably extend from or protrude from proximal side 20 of bracket 10, such that they have an upstanding sidewall 31. In use, a user will place an amount of bonding material 32 represented schematically on the attached drawings, on proximal side 20 of bracket 10. The user then presses proximal side 20 against the patient's tooth in an otherwise conventional manner. Material 32 is thus pressed between proximal side 20 and the tooth, which will cause the material 32 to be physically moved by the shrinking distance between the bracket 10 and the tooth as the user presses the bracket to the tooth, again as is conventional. According to the invention, flow path regulating structures 30 define a flow path generally indicated by the arrows 33 in FIG. 4, along which material 32 will move. It is to be appreciated that material 32 is of the conventional type that is soft and will be physically moved or spread by the pressing action of the user who applies a clinically relevant force to bracket 10. By preselecting the size and shape of flow path regulating structures 30 and hence, the areas between them which define a flow path represented by arrows 33, the movement of material 32 during placement of bracket 10 on a tooth is accomplished in a known and therefore, controlled manner. This helps to assure proper placement of bonding material 32 thus promoting proper bonding of bracket 10 to the patient's tooth. Thus, it is to be appreciated that the flow path or channels represented by arrows 33 may be bounded by proximal side 20, flow path regulating structures 30 and also by the patient's tooth when bracket 10 is placed thereon as is described herein.

In an exemplary embodiment of the invention shown in the drawings, flow path regulating structures 30 are round, upstanding columns. Although not shown, it will be appreciated that structures 30 can be of any number of shapes and sizes depending upon the desired flow paths. For example, structures 30 can be square, rectangular, triangular, oval, irregular in shape or indeed of any number of shapes (not shown) and still fall within the scope of the present invention. Further, while the invention is characterized herein as having four structures 30, any number of structures 1, 2 or more is within the scope of the invention. Further still, when a plurality of flow path regulating structures 30 are employed, each may be of the same or different size and shape from the others. Similarly, the spacing of the flow path regulating structures 30 may be regular as shown or irregular as may assist the desired flow path.

According to another aspect of the invention, proximal side 20 is provided with a well 40 with an upstanding wall 41. As depicted in the drawings, wall 41 surrounds well 40. A wall (not shown) similar to wall 41 that selectively or partially surrounded well 40 would also be within the scope of the invention. It will be appreciated that as material 32 flows along the flow path depicted by arrows 33 in the areas between structures 30, excess material may move into well 40, thereby reducing the potential or even eliminating unwanted flash. Proximal side 20 may also be provided with voids 50 for a similar purpose. In the embodiment depicted in the drawings, voids 50 are defined by void elements 51 and more particularly, the areas generally between void elements 51 and wall 40. Voids 50 thus provide a defined area for the containment of excess material 32, again reducing or helping to eliminate flash.

In one embodiment of the invention, well 40 has provided therein a pedestal 60 which supports flow path defining structures 30 and thereby contributes to the formation of flow paths 33. Void elements 51 may extend above or beyond the pedestal 60, such that void elements 51 form a supplemental flow path regulating function similar to flow path regulating structures 30. All such inventive structures discussed above, (including elements 30, 31, 40, 41, 50, 51, 60) may thus cooperate in a preselected manner to define the desired flow paths depicted by arrows 33. It will be further appreciated that the material 30 may be preselected with respect to its consistency, viscosity or the like to further cooperate with such flow path determination. Bracket 10 may be formed from any conventional material and may be fabricated by being for example, coined, molded, milled or the like as may otherwise be conventional in the orthodontic bracket art.

It will be understood that a bracket 10 according the present invention and as exemplified by the present description and drawings, will allow a user to bond the bracket 10 to a patient's tooth and will provide for a lower amount of flash or even substantially eliminate flash. There is thus, a reduced or even no need to clean excessive material after placement of the inventive bracket 10. The invention also provides a better control of the material 32 by defining the flow paths 33 in advance, providing consistent, controlled and known placement of material 32 which will lead to more consistent bonding strengths than would otherwise be known.

Having thus described at least one illustrative embodiment of the invention, various alterations, modifications and improvements will readily occur to those skilled in the art. Such alterations, modifications and improvements are intended to be within the scope of the invention. Accordingly, the foregoing description is by way of example only and is not intended as limiting.

What is claimed is:

1. An orthodontic bracket of the type to be bonded with a flowable and curable bonding material to a tooth, the bracket having a side proximal and a side distal to the tooth when placed thereon, the side proximal to the tooth comprising a plurality of flow path directing structures arranged in such a manner that an amount of the bonding material is caused to flow in a predetermined path when the bracket is placed on the tooth.

2. An orthodontic bracket as in claim 1, wherein said plurality of flow path directing structures include monolithic structures selected from posts and columns.

3. An orthodontic bracket as in claim 3, wherein said flow path directing structures have a shape are selected from round, square, rectangular, triangular, irregularly shaped or combinations thereof.

4. An orthodontic bracket as in claim 2, wherein at least one individual of said monolithic structures is of a different size from at least one other of said monolithic structures.

5. An orthodontic bracket as in claim 1 wherein the bracket proximal side is further provided with a catchment area wherein excess bonding material is directed by said flow path directing structures.

6. An orthodontic bracket as in claim 1 wherein the bracket further comprises a well having at least one of said flow path directing structures positioned therein, such that excess bonding material is directed into said well.
